(19) United States
(12) Patent Application Publication
(10) Pub. No.: US 2008/0077365 A1
(43) Pub. Date: Mar. 27, 2008

(54) Apparatus for loading CAD data

(75) Inventor: Yuichiro Fukumura, Fukuoka (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/903,969

(22) Filed: Sep. 25, 2007

(30) Foreign Application Priority Data
Sep. 27, 2006 (JP) 2006-263316

(51) Int. Cl. G06F 7/00

(52) U.S. Cl. 703/1

(57) ABSTRACT

To provide an automatic loading determination apparatus that completely loads necessary models without specification by a user, out of models for which complete loading is not specified, and suppresses the occurrence of waiting time due to complete loading when the user performs manipulations, for example, reference and editing, in which data other than display data is used, for the models, for which complete loading is not specified. Necessary models are completely loaded into a free area of a main memory within an appropriate range. Specifically, necessary models are predicted in advance, and complete loading is performed for not only models specified by a user but also the necessary models up to the capacity of a main memory at the maximum.

### BACKGROUND OF THE INVENTION

1. Field of the Invention

The present invention relates to apparatuses for loading CAD data, and in particular, relates to an apparatus for loading CAD data that loads data of parts out of all models that constitute a design object.

2. Description of the Related Art

In a CAD system, various types of data, for example, not only shapes but also information on features that form the shapes, dimensions, annotation information such as notes, and material information, are necessary to achieve higher functionality. Thus, when these pieces of data are handled in CAD, all the pieces of data need to be loaded into a memory. Accordingly, problems exist in that, for example, time to load data is necessary, and a large amount of memory is used.

In particular, much time is necessary and a large amount of memory is used for loading of, for example, a large-scale assembly.

In general, in a case where a design is produced using a CAD system, especially in the case of a large-scale assembly, in many cases, a unit for which a person is responsible or a unit to be designed by a person at that time is a portion, not a whole parts. In most cases, units other than a unit for which a person is responsible are used only to, for example, check the position of a design object of the person in the whole, and only the shape data is needed.

Thus, a general CAD system includes an optional function of loading only display data (polygon facets). Specifically, a user uses an optional function of performing complete loading to, regarding only a responsible unit, load (complete loading) data, for example, geometric data, attribute data, and annotation data, other than display data, and, regarding the other units, load (display loading) only display data. With this operation, the amount of memory used in a CAD system can be reduced, and the CAD system can be used comfortably without processing, such as swapping, being executed by an operating system (OS).

A technique for loading to a main memory of a CAD processing apparatus is disclosed in Japanese Unexamined Patent Application Publication No. 6-75774. In a CAD processing apparatus disclosed in this Japanese Unexamined Patent Application Publication, when a user selects a tool program other than tool programs loaded into the apparatus and when no free space is available in the main memory, specification of a tool program to be unloaded is accepted. Then, after a corresponding memory area is released by unloading the tool program, the tool program specified by the user is loaded.

However, in the aforementioned CAD system, which includes an optional function of performing complete loading, regarding a model for which complete loading is not specified, only data necessary for display is loaded in the memory, and reference and editing, for measuring models, that need data other than the display data cannot be performed in that status. FIG. 9 shows an assembly tree of a large-scale assembly model. In order to minimize the consumption of memory, only display data is loaded. The display data is polygon data and is not in a correct shape. Thus, in the current status in which only the display data is loaded, mathematical processing other than display cannot be performed.

Accordingly, when a model for which complete loading is not specified is referred to and edited, regarding the model subjected to this operation, for example, a user needs to activate complete loading by specifying complete loading on the illustrated assembly tree using an input unit such as a mouse (refer to FIG. 10), and needs to reload data, for example, geometric data, attribute data, and annotation data, other than display data from a file at that time. Thus, a problem exists in that a design operation by the user is interrupted while the content data is loaded. FIG. 10 shows that the user has selected a circled part 600 via an input unit to issue an instruction to completely load the circled part 600.

At this time, when the CAD system does not return a response within one to three seconds, the thought of the designer is interrupted. In many cases, the time necessary for loading from a file exceeds that number of seconds, and thus the thought of a designer is interrupted. In this case, many designers are conscious of only performing an editing operation and are not conscious of performing a loading operation. Thus, stress put on the designers is significant.

### SUMMARY OF THE INVENTION

The present invention is made to solve the aforementioned problems, and it is an object of the present invention to provide an automatic loading determination apparatus that completely loads necessary models without specification by a user, out of models for which complete loading is not specified, other than models to be completely loaded by specification by the user, and suppresses the occurrence of waiting time due to complete loading when the user performs manipulations, for example, reference and editing, in which data other than display data is used, for the models, for which complete loading is not specified, other than the models, for which complete loading is specified.

The stated invention will now be described item by item.

(1) An apparatus according to the present invention for loading CAD data performs display loading of parts that constitute a design object generated by a CAD system and performs complete loading of a part specified by a user. The apparatus for loading CAD data includes means for obtaining parts that constitute a management model, means for determining priorities on the basis of references to and/or updates of the obtained parts, means for performing complete loading of parts having high priorities until an allowable amount of memory is reached, and means for performing display loading of parts that are not completely loaded.

In this manner, in the present invention, priorities are determined on the basis of references to and updates of parts, and the parts are completely loaded according to priority until an allowable amount of memory is reached. Thus, even when, for parts specified not to be completely loaded, a user specifies an operation that requires data, other than data loaded by display loading, of the parts, the parts may be completely loaded, thereby achieving an effect in which the user is prevented from waiting for the parts subjected to the operation to be completely loaded. In particular, parts that are automatically and completely loaded are not selected at random, but are completely loaded according to priority. Thus, it is highly probable that the parts, which are automatically and completely loaded, are subjected to an operation.

Loading means transferring data from an external storage unit, such as a floppy disk (a registered trademark) or a hard disk, to a memory. Loading also includes receiving data from an external computer via a network and transferring the data to a memory.

A management model shows a mutual relationship, for example, between parts of the design object, the relationship contains the relation among a root assembly, an assembly, a sub-assembly, and a unit fall under the category.

Obtaining parts means obtaining data, for example, part names or part identification information, by which parts can be identified.

References to parts mean reference counts and/or reference times of parts.

Updates of parts mean update counts and/or update times of parts.

The order of priority is determined from the priorities of individual parts after determining the priorities of the parts by, for example, substituting reference counts and reference times of the parts into a predetermined equation.

In the present invention, the trigger for loading of CAD data may be the time of accessing CAD data upon activating a CAD system or a user's instruction while the user performs conventional loading of CAD data. Moreover, for the same CAD data, loading may be performed at predetermined intervals or every time a user's instruction is issued, not only once at the time of access, while the CAD data is referred to and edited. For example, this arrangement is suitable to, for example, a case where, when a design operation has been performed for a long time, parts that were designed at the beginning have been finished, and other parts are being designed.

The present invention can also be considered as a CAD apparatus or a CAD system that includes the aforementioned apparatus for loading CAD data.

(2) [Priority Depending on Function Type]

The apparatus according to the present invention for loading CAD data, as necessary, further includes means for determining whether a specified function or an executing function is a function for reference or a function for editing that needs data, other than display data, of parts. In a case where it is determined that the specified function or the executing function is a function for reference, a processor determines priorities, using only references or giving weights to references, using the means for determining priorities on the basis of references to and/or updates of the obtained parts, and in a case where it is determined that the specified function or the executing function is a function for editing, the processor determines priorities, using only updates or giving weights to updates, using the means for determining priorities on the basis of references to and/or updates of the obtained parts.

In this manner, in the present invention, for a specified function or an executing function, a distinction is made between a function for reference or a function for editing that needs data, other than display data, of parts. Then, in the case of a function for reference, priorities are determined, using only references or giving weights to references, and in the case of a function for editing, priorities are determined, using only updates or giving weights to updates. Thus, priorities can be determined in a manner that depends on a specified function or an executing function, thereby achieving an effect in which automatic complete loading corresponding to the status of usage by a user can be performed.

Determining priorities, using only references, means determining priorities, using reference counts and reference times, not using update counts and update times. Determining priorities, giving weights to references, means determining priorities, using reference counts, reference times, update counts, and update times, giving weights to reference counts and reference times.

Determining priorities, using only updates, means determining priorities, using update counts and update times, not using reference counts and reference times. Determining priorities, giving weights to updates, means determining priorities, using update counts, update times, reference counts, and reference times, giving weights to update counts and update times.

In this case, the apparatus according to the present invention for loading CAD data may further include means for determining whether a specified function or an executing function needs data, other than display data, of parts, and in a case where it is determined that the specified function or the executing function needs the data, other than the display data, of the parts, the step of determining whether a specified function or an executing function is a function for reference or a function for editing that needs data, other than display data, of parts is performed.

(3) [Priority Depending on Unit, Sub-Assembly, and Assembly]

The apparatus according to the present invention for loading CAD data, as necessary, further includes means for determining whether the proportion or number of parts that have been updated in each management model during a predetermined period the reference of which is the current time or since a predetermined time is equal to or more than a predetermined threshold value. In a case where it is determined that the proportion or number of parts that have been updated in each management model during the predetermined period, the reference of which is the current time, or since the predetermined time is equal to or more than the predetermined threshold value, for parts that constitute a management model that applies to the case, priorities that are higher than priorities assigned to parts that constitute a management model that does not apply to the case are determined, using the means for determining priorities on the basis of references to and/or updates of the obtained parts.

In this manner, in the present invention, priorities are not determined on the basis of only references to and/or updates of individual parts, but, for parts in a management model in which a certain number of parts out of the parts have been updated during a predetermined period or since a predetermined time, priorities that are higher than priorities assigned to parts in a management model that does not satisfy this condition are determined. Thus, priorities corresponding to a general situation in which a person is responsible for and designs each management model are determined, and when the parts are completely loaded in order of the priorities, it is highly probable that parts to be manipulated by a user are completely loaded, thereby achieving an effect in which a design operation can be smoothly performed by avoiding waiting time due to complete loading.

A predetermined period the reference of which is the current time means the time between the current time and a predetermined period ago. For example, when a predetermined period is one day, the time between the current time and one day ago corresponds to the predetermined period. A predetermined period may be set by a user.

A predetermined time may be set by a user. For example, the time of reading CAD data that is currently being subjected to a process last time or the time of reading the CAD data, which is currently being subjected to the process, this time correspond to a predetermined time. A predetermined time may be not only the time of reading but also the time of reference or the time of update. When the time of reading CAD data that is currently being subjected to a process last time is set as a predetermined time, for parts in each management model in which the proportion or number of parts that have been updated since the time of reading the CAD data last time is equal to or more than a predetermined threshold value, high priorities are determined. Thus, complete loading of parts in each management model that have been used many times in response to the last status of usage is facilitated, and thereby enabling complete loading corresponding to the status of usage by a user.

(4) [Index File]

The apparatus according to the present invention for loading CAD data, as necessary, further includes means for recording the references to and/or updates of parts in a common index file used by at least a plurality of parts.

In this manner, in the present invention, in contrast to a case where references to and/or updates of parts are recorded in a manner that requires separate accesses to the individual parts, references to and/or updates of a plurality of parts are recorded in an index file commonly used by the plurality of parts. Thus, when references to and/or updates of the plurality of parts are necessary, accesses corresponding to the number of the parts are not necessary, thereby achieving an effect in which references to and/or updates of a plurality of parts can be obtained merely by accessing the index file.

The reason why it is assumed that an index file is used by at least a plurality of parts is that there are a case where references to and/or updates of all parts in a management model are recorded in an index file, a case where references to and/or updates of all parts of CAD data are recorded in an index file, and a case where references to and/or updates of all parts to be processed are recorded in an index file. In any case, compared with a case where references and/or updates are recorded separately for individual parts, the number of accesses can be reduced by recording references and/or updates in a common index file. When references and/or updates are recorded separately for individual parts, for example, references and/or updates are recorded as the attributes of parts.

(5) [Release of Memory by Transition to Display Loading]

The apparatus according to the present invention for loading CAD data, as necessary, further includes means for determining whether parts are completely loaded with the allowable amount of memory being exceeded, and means for, when it is determined that parts are completely loaded with the allowable amount of memory being exceeded, making transition from complete loading to display loading for the completely loaded parts in ascending order of the determined priorities of the parts until the allowable amount of memory is not exceeded.

In this manner, in the present invention, when complete loading of parts is performed, exceeding a predetermined level, transition from complete loading to display loading is made for the completely loaded parts in ascending order of the determined priorities of the parts until the predetermined level is not exceeded, thereby achieving an effect in which the occurrence of malfunction due to the occupation of excessive memory by complete loading of parts can be avoided.

The trigger for applying the present invention is regularly executing the means for determining whether parts are completely loaded with the allowable amount of memory being exceeded while a CAD system is being executed.

In this case, the apparatus according to the present invention for loading CAD data may include means for detecting that completion loading in response to an instruction from a user has been performed, and the means for determining whether parts are completely loaded with the allowable amount of memory being exceeded may be executed after the detection.

The present invention can be considered as a method and a program.

The aforementioned summary of the invention does not include features mandatory for the present invention, and sub-combinations of the plurality of features may also be the invention.

### BRIEF DESCRIPTION OF THE DRAWINGS

FIG. 1 shows that the type of necessary loading varies with the status of a par;

FIG. 2 shows a schematic hardware block diagram of a computer in which a CAD system according to a first embodiment of the present invention is constructed;

FIG. 3 shows a schematic block diagram of the CAD system according to the first embodiment of the present invention;

FIG. 4A shows an example of an index file according to the first embodiment of the present invention and FIG. 4B shows examples of update tables and reference tables;

FIG. 5 shows a schematic flowchart of assembly loading of the CAD system according to the first embodiment of the present invention;

FIG. 6 shows a schematic flowchart of part loading of the CAD system according to the first embodiment of the present invention;

FIG. 7 shows a schematic flowchart of model activation of the CAD system according to the first embodiment of the present invention;

FIG. 8 shows a schematic flowchart of assembly loading of a CAD system according to another embodiment of the present invention;

FIG. 9 shows an example of an assembly tree; and

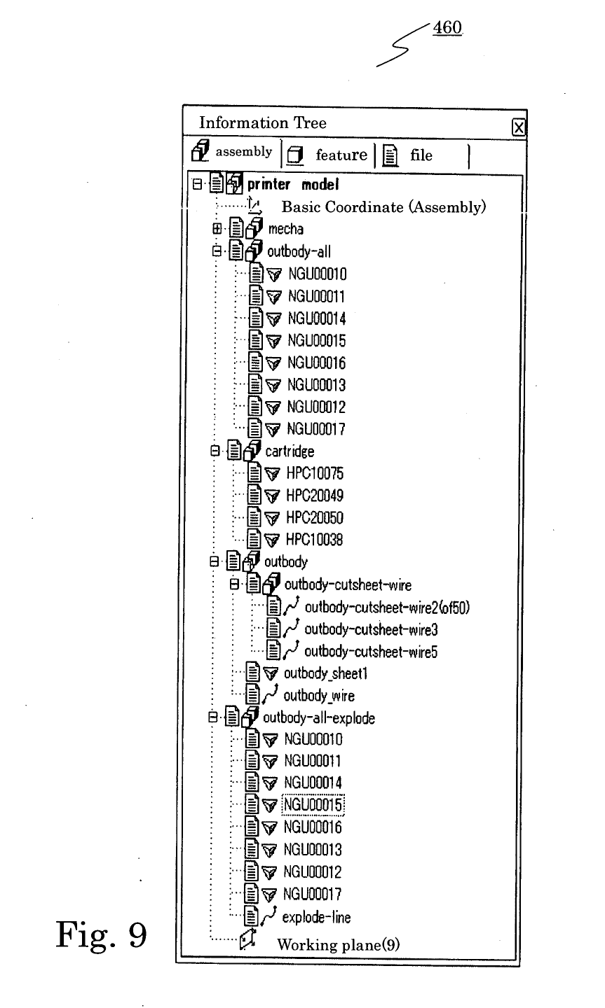

FIG. 10 shows that a user has issued an instruction to perform complete loading using an assembly tree.

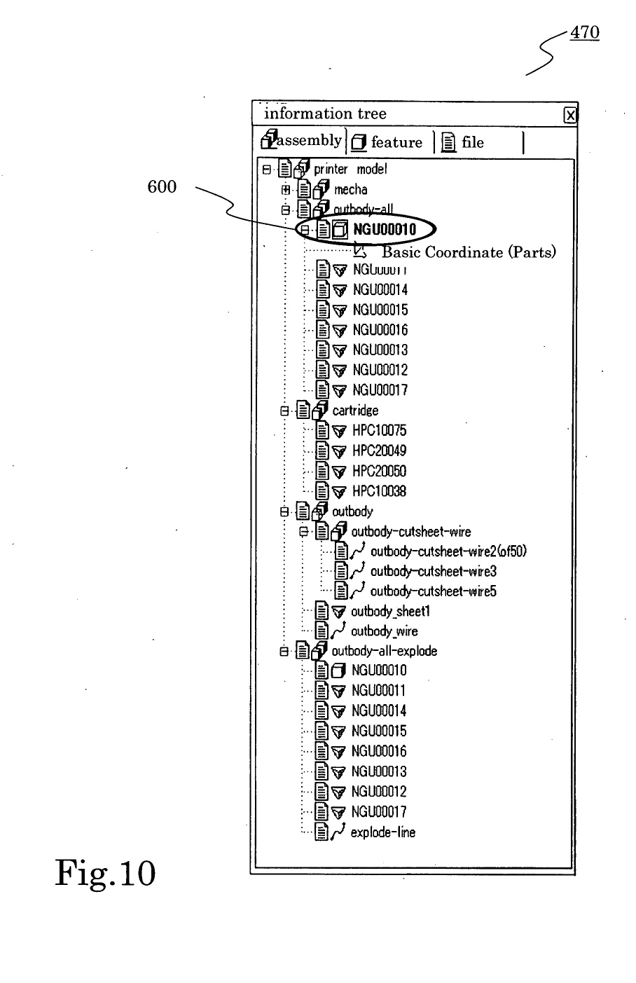

### DESCRIPTION OF THE PREFERRED EMBODIMENTS

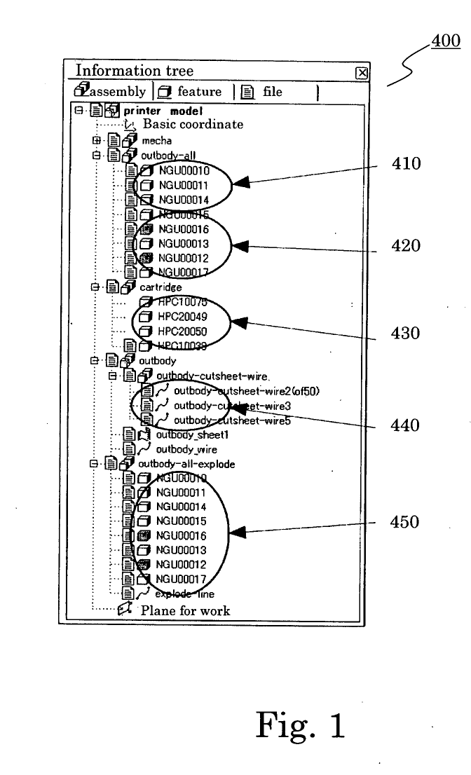

In current computer systems, the level of integration of semiconductor recording elements is high compared with the conventional level of integration, and the sales price per unit has significantly decreased. Thus, many computer systems include a large-capacity memory. In particular, in computer systems in which CAD systems are constructed, the memory capacity becomes large. On the other hand, as design objects designed in CAD systems become complicated, the amount of data tends to increase year by year. However, only all data including display data and content data of a model does not put a strain on a main memory, and there is room for loading not only display data but also content data of other models. Thus, necessary models are completely loaded into a free area of a main memory within an appropriate range. Specifically, necessary models are predicted in advance, and complete loading is performed for not only models specified by a user but also the necessary models up to the capacity of a main memory at the maximum (refer to FIG. 1). The parts circled 410 shows the recently stored parts and these parts have high possibility to be edited. The parts circled 420 are not accessed but the other parts in the same unit are edited and stored, and then the parts have high possibility to be edited. As the parts circled 430 have not been accessed, the parts circled 430 may be loaded by display loading. The parts circled 440 and 450 have been accessed for reference not for editing, the priority is high when the command for reference is executed, while the priority is not high when the command for editing is executed. In this arrangement, in a case where a user manipulates models other than models specified by the user, when the models are the models having been predicted in advance, the models have been already completely loaded. Thus, the user can continuously perform a design operation without waiting for a period of time necessary for complete loading of the models.

In this case, there are many models that are not completely loaded, other than the models, for which complete loading is specified by the user, out of all models that constitute a design object. Thus, models that will be necessary for the user need to be predicted. In the present invention, priorities are determined among models that are not completely loaded, and complete loading is performed for models having high priorities. The following items of information are used to determine the priorities of models.

The last reference time

The last save time

The reference count (Frequency of referencing the data)

The save count (Frequency of saving the data)

It is determined on the basis of the status of free memory at the time which models are completely loaded. For example, a portion of all the memory capacity is used up to a predetermined threshold value [%].

The aforementioned conditions are examples. Each of the conditions can be used as a single condition. Moreover, a plurality of the conditions can be used in combination. In the latter case, for example, reference times, save times, reference counts, and save counts are set as parameters, and the weights of the priorities of models are determined. Then, a point is determined for each data access. In this case, the closer the data access is to the current time, the higher the point. For example, weights are determines according to the following equation:
[Method for Considering Priority of Model According to Date]

$$( Date Point ) = \frac{α}{( ( Current time ) - ( Last Reference Time ) )} + \frac{α}{\begin{matrix}( ( Current time ) - \\ ( Time of Reference before Last Reference ) )\end{matrix}} + … + \frac{α}{( ( Current time ) - ( Second Oldest Reference Time ) )} + \frac{α}{( ( Current time ) - ( Oldest Reference Time ) )} \qquad ( 1 )$$

α: Arbitrary Coefficient

According to equation (1), when the reference count is high and references were performed at times close to the current time, a high date point is determined. Thus, for a model for which, although the access count is high, most of accesses were performed in the past distant from the current time, the date point is low, and the priority is also low. On the other hand, for a model for which, although the access count is low, most of accesses were recently performed, the date point is high, and the priority is also high. That is to say, the priority of the former model is lower than the priority of the latter model. Thus, in a manner that depends on the status of free memory, a case may occur, in which the latter model is completely loaded, and the former model is not completely loaded.

[Method for Considering Priority Depending on Function Type]

Since a distinction is made between reference times and save times, different methods for predicting priorities can be used in a manner that depends on an intended function (for example, a function of editing models or a function of referring to models). For example, in a case where a priority for loading a model is determined while a function of measuring the volume of a model is being executed, because the function requires a reference operation and does not require a save operation, the priority may be determined, disabling parameters (save count and save times) for a save operation, enabling parameters (reference count and reference times) for a reference operation. When this is applied to the following equation (2), in order to disable parameters for a save operation and enable parameters for a reference operation, a date point is determined, setting α2 to zero. On the other hand, in order to disable parameters for a reference operation and enable parameters for a save operation, a date point is determined, setting α1 to zero. In this case, even when α1 (or α2) is not set to zero, a similar date point can be obtained by setting α1 (or α2) to a value that is sufficiently smaller than the value of α2 (or α1).

In this case, for convenience of illustration, equation (2) is used, in which an equation (the left side of the right side) related to reference times and an equation (the right side of the right side) related to save times are clearly separated from each other.

$$( Date Point ) = \frac{α1}{( ( Current time ) - ( Last Reference Time ) )} + \frac{α2}{( ( Current time ) - ( Last Update Time ) )} + \frac{α1}{\begin{matrix}( ( Current time ) - \\ ( Time of Reference before Last Reference ) )\end{matrix}} + \frac{α2}{( ( Current time ) - ( Time of Update before Last Update ) )} + … + \frac{α1}{\begin{matrix}( ( Current time ) - \\ ( Time of Reference before Last Reference ) )\end{matrix}} + \frac{α2}{( ( Current time ) - ( Second Oldest Update Time ) )} + \frac{α1}{( ( Current time ) - ( Oldest Reference Time ) )} + \frac{α2}{( ( Current time ) - ( Oldest Update Time ) )} \qquad ( 2 )$$

The case of functions for reference (interference, verification, analysis, and the like): α1>α2

The case of functions for editing (shape editing, attribute addition, and the like): α2>α1

[Method for Considering Priority of Model Depending on Unit]

In a case where a plurality of types of part exist in a unit that constitutes an assembly, when the save time of one of the parts is new, this can be considered to be simple specification change. On the other hand, when the save dates of a plurality of parts in the same unit are new, it can be determined that the other units included in the same unit will also probably be edited and saved. Thus, in this case, it is preferable that high priorities be set for all the parts in the same unit.

For example, when as many parts as a predetermined threshold value that are edited on the current day exist in the same unit as a certain part, the weights of these parts are increased by, for example, increasing the points of the parts by fifty percent. It is assumed that the predetermined threshold value (for example, an absolute number or a proportion in a unit) and the rate of increasing points can be specified by a user via parameters.

[Index File]

The fewer the number of accesses to a file the better. Thus, in order to eliminate the necessity of access to all models to obtain data for determining priorities, an index file is set up and the attributes of individual files necessary for prioritization are gathered in the same place so that the attributes can be determined by accessing only that file.

[Status of Free Memory]

For determination on a memory, the amount of free memory at the time of starting loading of an assembly is measured. Then, a predetermined threshold value, for example, about 70 [%] of the amount of free memory, is set, and complete loading is performed up to the predetermined threshold value. Conversely, a predetermined threshold value, for example, about 30 [%] of the amount of free memory, may be set for free memory that must not be used by a CAD system or the present invention, and complete loading may be performed until the predetermined threshold value is reached. The object is to reduce the use of a virtual storage for, for example, swapping (i.e., saving data in a memory space in a hard disk). It is assumed that a user can specify the predetermined threshold value. While it has been described that, assuming that a proportion of free memory is a predetermined threshold value, necessary parts are completely loaded until the predetermined threshold value is reached, a proportion of memory including physical memory or virtual memory, not free memory, may be set as a predetermined threshold value. Moreover, while it has been described that a predetermined threshold value is a proportion, the predetermined threshold value may be the amount of memory.

[Release Process Triggered by New Complete Loading]

When models that have not been completely loaded because there was no specification by a user and the priorities were low are activated because the models need to be edited, complete loading is performed. In this case, the status of free memory is checked, and models that have been already completely loaded are released in ascending order of priority as necessary until a predetermined condition is satisfied. When memory is released, related models are saved as necessary.

### First Embodiment of the Present Invention

An apparatus according to a first embodiment of the present invention that loads CAD data will now be described as a function incorporated in a CAD system.

[1. Hardware Configuration]

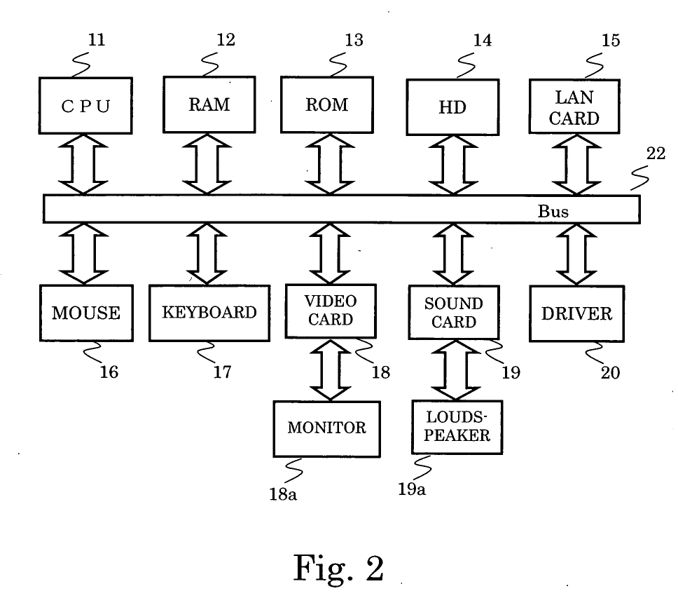

FIG. 2 is a hardware block diagram of a computer system in which a CAD system according to the present embodiment is constructed. The computer system, in which the CAD system is constructed, includes a central processing unit (CPU) 11, a main memory 12, such as a dynamic random access memory (DRAM), ROM 13, an information storage device 14, such as a hard disk (HD) 14, that is an external storage unit, a LAN card 15 that is an expansion card for connecting to a network, a mouse 16 and a keyboard 17 that are input units, a video card 18 that includes a screen display function, a sound card 19 that includes an audio input-and-output function, a display 18a and a speaker 19a that are output units, and a CD-ROM drive 20 that reads data from a CD-ROM.

The CAD system is constructed in the computer by performing what is called installation in which a CAD program recorded in an external storage medium, such as a CD-ROM, is copied to the HD in the computer, and the CAD program is set in a status in which the CAD program is readable and executable.

Various types of function necessary for design are provided in the CAD system. In the present embodiment, loading of CAD data will be described as one of these functions. In this case, the apparatus, which loads CAD data, may exist alone, and an arrangement may be adopted, in which, for example, a loading process of CAD data is executed in response to a request from the CAD system.

[2. Block Configuration]

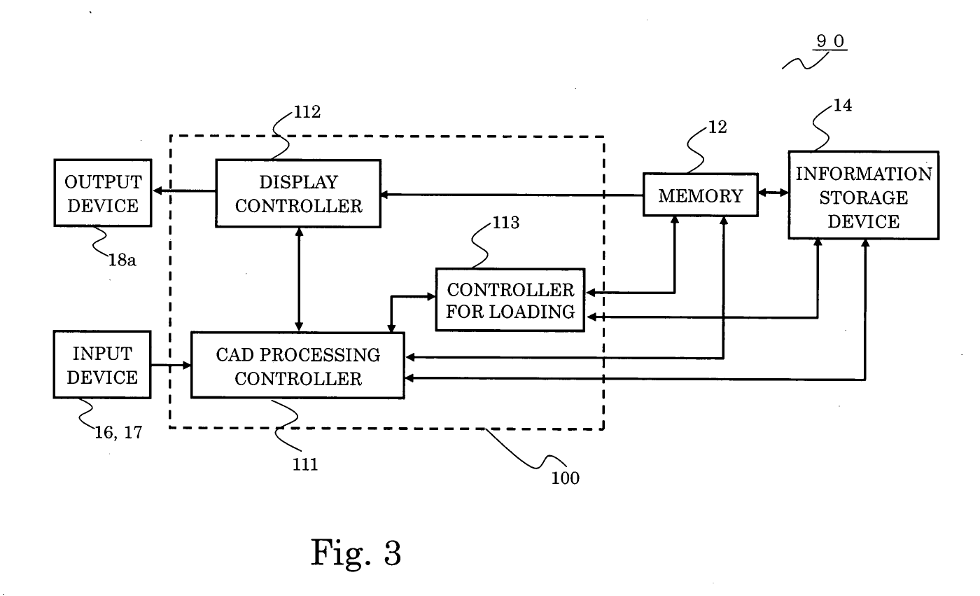

FIG. 3 is a function block diagram of the CAD system 90 according to the present embodiment. The CAD system 90 is controlled by a control unit 100 comprising a CAD processing control unit 111, a display control unit 112, and a load control unit 113. The control unit 100 can be implemented by execution of programs, read into the memory 12, by the CPU 11.

The CAD processing control unit 111 performs CAD processing, such as creation and editing of CAD data, in response to various types of instruction from a user. For example, upon receives an instruction to open a file from a user, the CAD processing control unit 111 reads CAD data from the storage unit 14 via the load control unit 113, loads the CAD data into the memory 12, and accepts the instruction from the user. Functions provided to users are displayed on a toolbox and a menu bar on a GUI displayed on the screen of the display 18a. A user issues an instruction by selecting a function on the toolbox and menu bar and specifying a model displayed on a model drawing area. The CAD processing control unit 111 performs processing concerned with the instruction from the user upon receiving the instruction. The CAD processing control unit 111 may load CAD data and programs from the storage unit 14 without the intervention of the load control unit 113. Needless to say, an arrangement can be adopted, in which only the load control unit 113 performs loading.

Moreover, the CAD processing control unit 111 includes a function of, upon reference to and updating of a part, recording the part in an index file described below. The display control unit 112 displays data processed by the CAD processing control unit 111 on the output unit 18a according to a control instruction from the CAD processing control unit 111. For example, the display control unit 112 displays primitives created by the CAD processing control unit 111 in response to a request from a user.

The load control unit 113 performs complete loading of parts in a manner that depends on the amount of free memory and the priorities according to a control instruction from the CAD processing control unit 111. In other words, the load control unit 113 performs complete loading of parts according to priority within an allowable amount of memory. In the background art, only parts specified by a user are completely loaded. On the other hand, in the present invention, even parts that are not specified by a user but, subsequently, will probably be loaded completely according to an instruction from the user are completely loaded with priority so as to cut the time between issuing an instruction to completely load the parts by the user and newly and completely loading the parts, thereby improving the convenience. The load control unit 113 also includes a function of display loading and a function of completely loading a part specified by a user.

It was described that the load control unit 113 includes a function of determining the priorities of parts by obtaining data from an index file and completely loading the parts according to priority until the amount of free memory reaches an allowable value. The load control unit 113 includes not only this function but also a function of, when parts specified by an instruction from a user are completely loaded and when the amount of free memory falls below an allowable value as a result of the complete loading, performing display loading of the parts completely loaded by the load control unit 113 in ascending order of priority until the amount of free memory exceeds the allowable value. In this case, when complete loading transitions to display loading, it is determined whether corresponding parts are being updated. When the parts are being updated, data of the parts is updated. In this case, an arrangement may be adopted, in which, regarding parts that are being updated, transition from complete loading to display loading is not made. For transition from complete loading to display loading, a method for first releasing all data loaded by complete loading of parts and then performing display loading, or a method for releasing data, leaving only data loaded by display loading of parts, can be adopted.

[2.1 Amount of Free Memory]

The amount of free memory is the amount of available memory. The amounts of memory include the amount of physical memory and the amount of memory including the amount of virtual memory. In the present embodiment, it is assumed that the amount of memory is the amount of physical memory, and the amount of free memory is the amount of memory available in the amount of physical memory.

In the present embodiment, parts are completely loaded until the amount of free memory reaches an allowable value. An allowable value may be a variable value that can be set by a user. In the present embodiment, it is assumed that the amount of physical memory multiplied by a predetermined threshold value [%] is an allowable value, as an example. For example, assuming that the amount of physical memory is 512 [MB], up to 70 [%] of the amount of physical memory is used in this system, and a predetermined threshold value is 30 [%], an allowable value is about 150 [MB].

[2.2 Priority]

In the present embodiment, assuming that a part is an object unit, the priority of each part is determined, and complete loading is performed in descending order of priority until the amount of free memory reaches an allowable value. The priorities of parts are determined from reference times and reference counts of the parts. Specifically, the aforementioned equation (1) is used. Thus, the CAD system needs to record reference times and reference counts of the parts in advance. Then, the priorities are determined by substituting the recorded reference times and reference counts of the parts into equation (1). The priorities are determined for the individual parts, and the parts are sorted in descending order of priority. In the present embodiment, it is assumed that a part is an object unit. A component of a design object, for example, a model, a unit, a sub-assembly, an assembly, or a file, in the CAD system may be an object unit. Moreover, in the present embodiment, reference times and reference counts of parts are used. Alternatively, update times and update counts may be used. The priorities may be determined using the aforementioned equation (2) in which reference times, reference counts, update times, and update counts are used.

[2.3 Index File]

Reference times and reference counts of parts are recorded in an index file. A method for recording reference times and reference counts of all parts separately is superior to a method for recording reference times and reference counts for individual parts as the attribute data of the parts in that a merit is achieved, in which, when reference times and reference counts of parts are obtained to determine the priorities, the attribute data of the individual parts need not be read out, and the priorities of all the parts can be determined by accessing an index file. It is preferable that an index file be created for each computer or each user. However, when an index file is used by a plurality of computers or a plurality of users, the index file can be used separately by the individual computers or users. The data exists in the form of an index file. Alternatively, the data may not exist as a file and may exist so that the data is included in other unified data. For example, the data may be included in the root information of a design object, such as assembly information and project information, or may be included in the system data of each computer and the profile data of each user. When an index file is created for each computer or each user in this manner, the priorities of parts are determined in a manner that depends on the operating status of the CAD system of each computer or the operating status of the CAD system of each user. Thus, complete loading of parts is performed in an optimal manner for each computer or each user. When a common index file is used by all computers or all users, priorities under an average operating condition of all the computers or users are determined. Thus, an optimal condition of complete loading of parts is not necessarily achieved for a computer that is currently being used or a user.

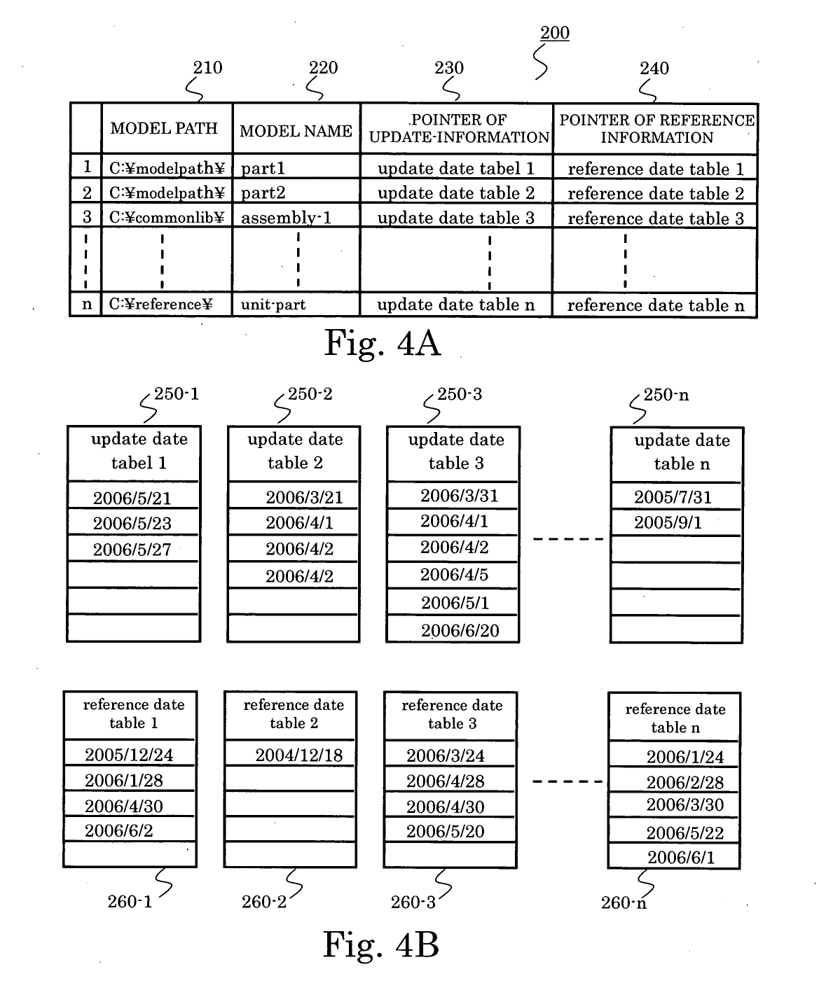

FIG. 4A shows an example of an index file 200 according to the present embodiment. The index file 200 as one of data of the CAD data is stored in the memory 12 or the information storage device 14. The index file 200 includes fields of a model path 210, a model name 220, an update information pointer 230, and a reference information pointer 240. The model path 210 is a path that indicates the location of a file of a model. The model name 220 is the name of a file of a model. The update information pointer 240 indicates the location of update information. The reference information pointer 240 indicates the location of reference information. In the example in FIG. 4A, an arrangement is adopted, in which a part, an assembly, and a unit each exist as a file. Alternatively, another arrangement may be adopted, in which a single file includes parts, assemblies, and units. When a part, an assembly, and a unit each are a file, update dates and reference dates of a file may be used. The CAD system keeps track of which model has been updated and referred to and thus can update the index file. Updating and reference operations may be detected when a user has issued an instruction or when a function according to the instruction has been performed. FIG. 4B shows update tables 250-1, . . . , 250-n, and reference data tables 260-1, . . . , 260-n which are linked to the pointers of up-date information 230 and reference information 240, respectively. In the tables 250-1 and 260-1, and so on, the dates of updating or referencing the file are recorded.

[3. Operation]

The main operating component is the CAD system 90, which is a program in the present embodiment and is the CPU in terms of hardware. Moreover, the CAD system 90 structure can be composed in various ways, such as hard wares, as is apparent to those skilled in the art. Even the same program can be implemented with different functions being provided in the module.

[3.1 Assembly Loading]

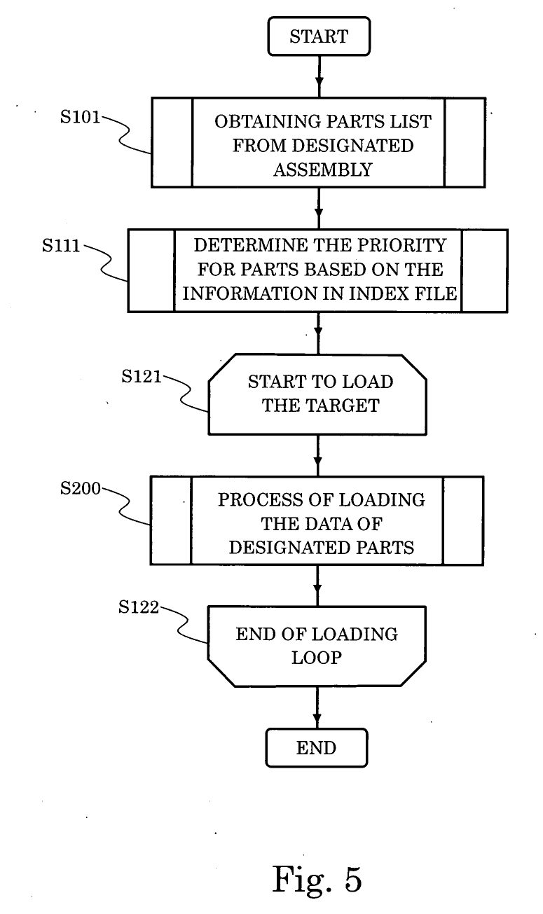

FIG. 5 is a flowchart of assembly loading of the CAD system 90 according to the present embodiment. When a user issues an instruction to activate the CAD system 90 via the input unit 16, such as the mouse, an installed CAD program is read from the hard disk to the main memory, and the CAD system is put in a status in which the CAD system is ready for use.

The CAD system prompts the user to open a file via the display. The user specifies a file of CAD data via the input unit, such as the mouse 16. When a file includes both assemblies and parts, the user specifies the file. When different files include assemblies and parts, the user specifies the file of assemblies. The load control unit 113 reads assembly information from the file specified by the user and obtains a list of part names (step 101). As a result, an assembly tree can be displayed. Assembly information includes a list of the names of parts that constitute design objects and the locations and poses of the parts. An assembly tree shows an assembly that is a root assembly top, sub-assemblies, and parts that are components in a hierarchical fashion. An arrangement may be adopted, in which the CAD processing control unit 111 reads assembly information, and the load control unit 113 obtains a list of part names.

The load control unit 113 also reads an index file, determines the priorities of individual parts using equation (1), and sorts parts to be loaded in descending order of the determined priorities (step 111). The process of loading parts (step 200) that is a defined process is performed according to priority until there is no part to be loaded. The process of loading parts is described in the next section. The specified assembly is drawn on a model display area by this loading operation, and the user can perform a design operation.

[3.2 Part Loading]

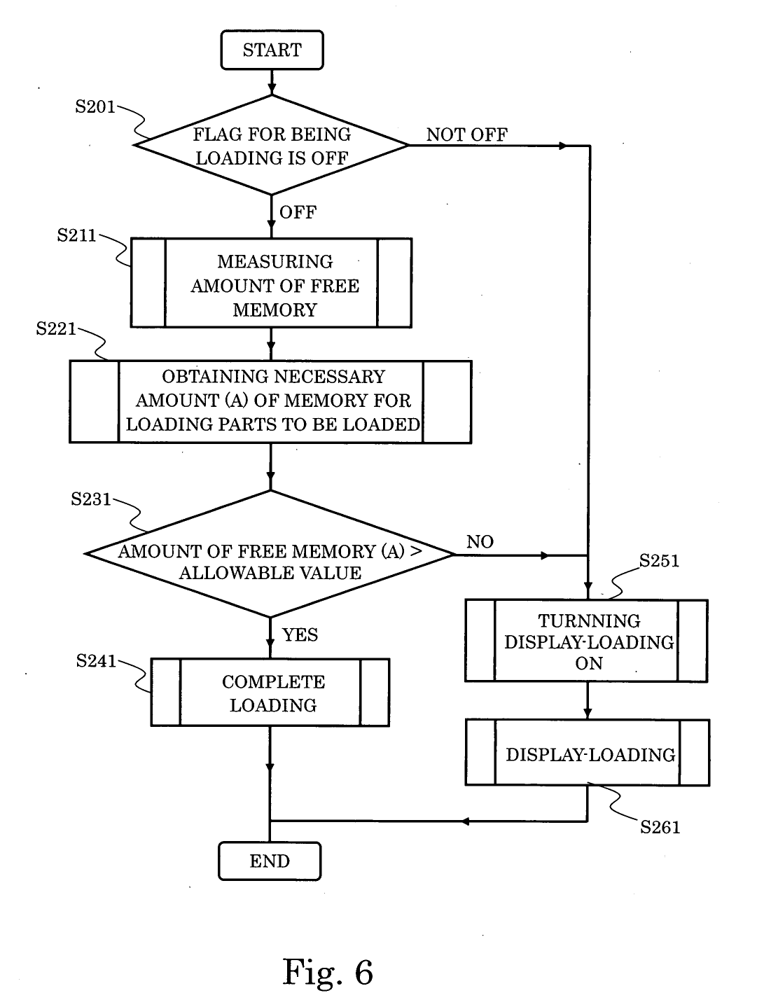

FIG. 6 is a flowchart of part loading of the CAD system according to the present embodiment. The load control unit 113 determines whether a display loading flag attached to the part to be looped is off (step 201). When the load control unit 113 determines that the display loading flag is off, the load control unit 113 measures the amount of free memory (step 211). That is to say, the amount of free memory is obtained from an OS using a system call. In step 201, the display loading flag is not off (NO in step 201), the process moves to step 251, and the display loading flag is changed to ON.

The load control unit 113 determines the amount of memory that is necessary when parts to be loaded are loaded into the main memory (step 221). For example, data of parts to be loaded in a file is determined, and the amount of data is determined from the beginning and end of the data. The amount of memory that was necessary at the previous loading of parts to be loaded may be recorded at the time of storing the parts, and the amount of memory that is necessary when parts to be loaded are loaded into the main memory may be determined by reading the recorded amount of data.

The load control unit 113 determines the difference between the obtained amount of free memory and the obtained amount of memory necessary for parts to be loaded and determines whether the difference is larger than an allowable value (step 231).

When the load control unit 113 determines that the difference is larger than the allowable value, the load control unit 113 completely loads the parts to be loaded (step 241).

On the other hand, when the load control unit 113 determines that the difference is not larger than the allowable value, the load control unit 113 turns the display loading flag on so as to avoid duplicate execution of the process for the following parts to be loaded (step 251). Then, the load control unit 113 performs display loading of parts to be loaded (step 261).

[3.3 Model Activation]

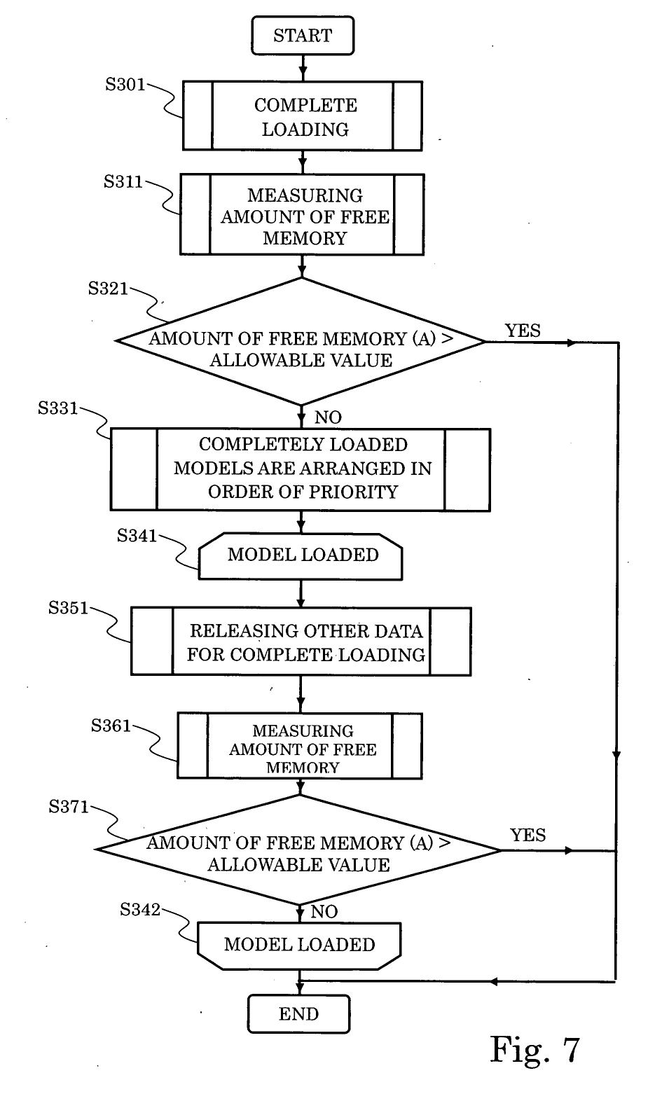

FIG. 7 is a flowchart of model activation of the CAD system according to the present embodiment. The user knows by, for example, the icon of a part to be edited on the assembly tree that the part is in a display loading status. Then, the user issues an instruction to completely load the part via the input unit, such as the mouse 16, so as to edit the part.

The load control unit 113 completely loads the specified part upon receiving the instruction from the user (step 301). The load control unit 113 obtains the amount of free memory (step 311). The load control unit 113 determines whether the obtained amount of free memory is larger than an allowable value (step 321).

When the load control unit 113 determines that the amount of free memory is not larger than the allowable value, the load control unit 113 sorts, according to priority, parts that have been completely loaded (step 331). As the priorities, those determined in step 111 may be used, or the load control unit 113 may newly determine the priorities.

Then, the following steps between steps 341 and 342 are performed in order the priority for the parts having been completely loaded (steps 341 and 342).

The load control unit 113 leaves only data for display loading of the target parts having been loaded and releases other data for complete loading (step 351). The load control unit 113 may release all data for complete loading and then again perform display loading of the corresponding parts.

The load control unit 113 obtains the amount of free memory (step 361). The load control unit 113 determines whether the obtained amount of free memory is larger than the allowable value (step 371). When the load control unit 113 determines that the amount of free memory is larger than the allowable value, the process goes to end.

When the load control unit 113 determines that the amount of free memory is not larger than the allowable value, the process goes back to the top, step 341, of the loop.

### Other Embodiments

[Method for Determining Priority Depending on Function Type]

An arrangement may be adopted, in which the method for determining priorities is changed on the basis of functions that are currently specified or executed. In this arrangement, users can smoothly perform a design operation without waiting time by maximizing the utilization of limited resources.

Functions provided to users in the CAD system can be classified roughly into functions for reference of not updating data of models and functions for editing of updating data of models. Specific examples of functions for reference are functions such as interference, verification, and analysis. Specific examples of functions for editing are functions such as shape editing and attribute addition. These functions are functions that cannot be executed only with display data. For example, geometric data, not display data, is needed for verification of interference and shape editing.

In the aforementioned first embodiment, the priorities of parts are determined according to equation (1) in S111 in FIG. 5, and it has been described that update counts and update times, other than reference counts and reference times, are used, or these items are used in combination. In this case, equation (2) is used.

In this case, the time of starting the process shown in the flowchart in FIG. 5 is different. Specifically, when functions that are currently specified or executed change, the process in FIG. 5 is performed, so that parameters in equation (2) are changed in a manner that depends on which of functions for reference or functions for editing are specified or being executed, and priorities are determined.

[Method for Determining Priority Considering Manipulation of Components of the Same Unit, Sub-Assembly, and Assembly]

An arrangement is adopted, in which, when the proportion of parts that have been updated during a predetermined period, the reference of which is the current time, is equal to or more than a predetermined threshold value in a unit, a sub-assembly, or an assembly, parts that belong to the unit, the sub-assembly, or the assembly are completely loaded with priority. A part can be completely loaded with priority by increasing the priority of the part to be determined by increasing a coefficient in an equation, or by increasing the priority.

This arrangement may be applied when a user specifies a file and assembly information is read, as in the flowchart in FIG. 5, or may be performed at predetermined intervals while a user is performing a design operation after the process in the flowchart in FIG. 5 is performed.

While it has been described that the predetermined period is determined with the current time being the reference, the predetermined period may be determined as being a period during which the current file was opened last time or a period during which the current file is open.

[Method for Determining Priority of Part Near Specific Part]

An arrangement may be adopted, in which, when an object to be manipulated is changed, parts near a part that is set as an object to be manipulated are completely loaded in ascending order of distance from the part. Parts near a part that is set as an object to be manipulated are completely loaded with priority by using the following equation (3).

$$Priority = \frac{α}{Distance of Object Part}$$

α: Arbitrary Coefficient

An arrangement may be adopted, in which priorities are determined using an equation obtained by adding equation (3) to the equation, which includes reference counts, reference times, update counts, and update times.

Moreover, another arrangement may be adopted, in which priorities are determined using reference counts, reference times, and the like, not using distances, as in the first embodiment, a part having the highest priority out of the determined priorities is set as a specific part, and parts near the specific part are completely loaded in ascending order of distance from the specific part.

[Specification for Prohibiting Automatic Loading]

All parts that constitute an opened assembly are subjected to automatic complete loading, for example shown in FIG. 6, by the load control unit 113. Alternatively, another arrangement may be adopted, in which specification, by a user, of parts, sub-assemblies, units, and assemblies for which automatic complete loading is not performed is accepted, and automatic complete loading is not performed for the specified parts, parts that constitute the sub-assemblies, parts that constitute the units, and parts that constitute the assemblies. Specifically, parts for which it is specified that automatic complete loading is not performed are removed from the list of parts obtained in S101 in FIG. 5, and, in S111, for the parts involved in the specification, priorities are not determined.

[Time of Loading Process]

In the aforementioned first embodiment, the amount of memory necessary for parts to be loaded is determined in S221, and then loading is performed after the amount of free memory minus the amount of necessary memory is compared with the allowable value. In this case, it is first determined which parts can be completely loaded. Then, complete loading of parts determined to be subjected to complete loading is performed, and displaying loading of parts determined to be subjected to display loading is performed.

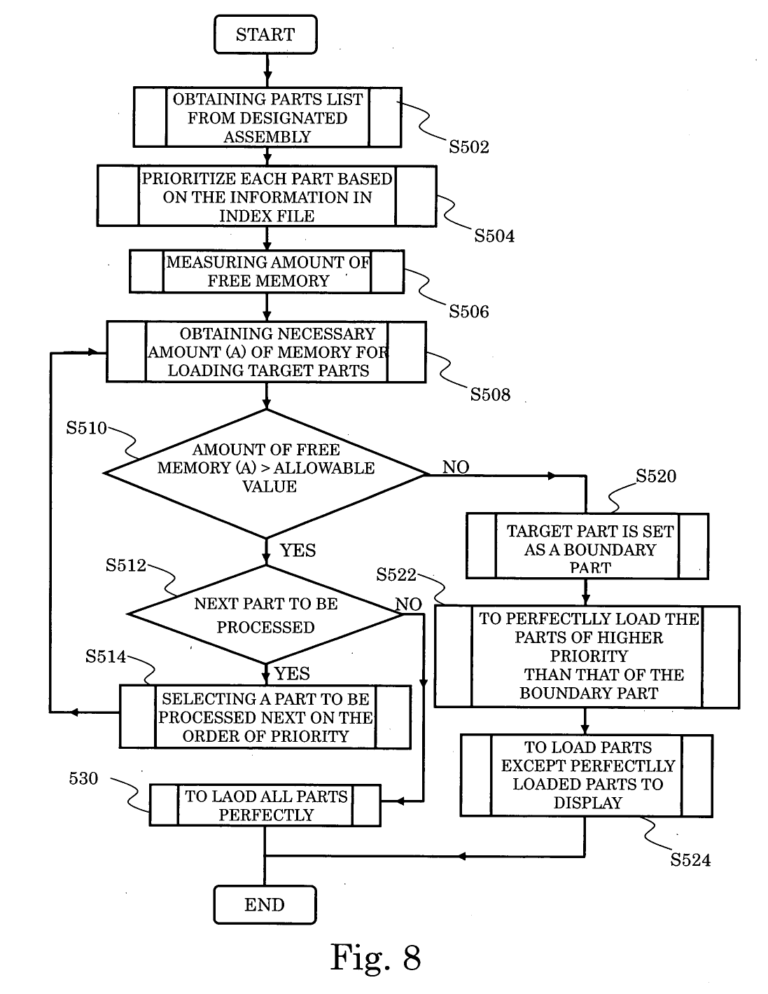

FIG. 8 is a flowchart of assembly loading of a CAD system according to the present embodiment. The load control unit 113 reads assembly information from the file specified by the user and obtains a list of part names (step 502). The load control unit 113 also reads an index file, determines the priorities of individual parts using equation (1), and sorts parts to be loaded in descending order of the determined priorities (step 504). Then in step 506, the free memory is measured. In step 503, the necessary amount of memory for loading the target parts is obtained. When it is determined in step 510 that the allowable value is exceeded, the load control unit 113 determines whether the next part exists (step 510). When the next part exists, an object part is set as the next part (step 514), and the process returns to step 508. When the next part does not exist, all parts are completely loaded (step 530), and the process is completed. When it is determined in step 510 that the allowable value is not exceeded, the CPU sets an object part as a boundary part (step 520). The load control unit 113 completely loads parts having priority over the boundary part (step 522). The load control unit 113 performs display loading of parts other than the completely loaded parts (step 524). Performing complete loading and display loading at the same time in this manner may enhance the speed of loading to a memory.

While the present invention has been described via the aforementioned embodiments, the technical scope of the present invention is not limited to the scope described in the embodiments, and various changes or improvements can be made in the individual embodiments. The embodiments that are changed or improved are included in the technical scope of the present invention. This is apparent from the claims and means for solving the problems.

What is claimed is:

1. An apparatus for loading computer-aided design (CAD) data generated by a CAD system, the CAD data including a plurality of pieces of CAD data for parts constituting a design object, the apparatus capable of loading the CAD data in forms of a display-loading or a complete loading, the display-loading being a loading of CAD data of a part to display the part, the complete loading being a loading of CAD data of a part to update or reference the CAD data, the apparatus comprising:
obtaining part for obtaining the CAD data of parts;
determining part for determining priorities of each of the pieces of the CAD data on the basis where the obtained CAD data of the parts is referenced and/or updated in the CAD system;
performing part for performing the complete loading of the CAD data of the parts in order of priority until an allowable amount of memory is reached; and
performing part for performing the display-loading of parts that are not completely loaded.

2. An apparatus according to claim 1, wherein the loaded CAD data is stored in a memory of the CAD system.

3. An apparatus according to claim 1, wherein a relation among the parts is managed by a management model.

4. An apparatus according to claim 1, wherein the apparatus in included in the CAD system.

5. An apparatus for loading CAD data according to claim 1, further comprising:
determining part for determining whether a specified function or a function in executing is a reference function and/or a update function, the specified function and the function in executing being performed in the CAD system, the reference and the update functions requiring the CAD data other than the display data, wherein the means for determining priorities determines the order of priority, providing that the obtained CAD data is used in executing the reference function in a case where the specified function or the function in executing is the reference function.

6. An apparatus for loading CAD data according to claim 1, the apparatus further comprising:
determining part for determining whether a specified function or a function in executing is a reference function and/or a update function, the specified function and the function in executing being performed in the CAD system and requiring the CAD data other than the display data, wherein the means for determining priorities determines the order of priority, providing that the obtained CAD data is used in the update function in a case where the specified function or the function in executing is the updating function.

7. An apparatus for loading CAD data according to claim 1, further comprising:
determining part for determining whether a proportion or number of parts in a group is equal to or more than a predetermined value, the parts being updated during from a current time to a date back to a predetermined period or updated since a predetermined time, wherein the order of priority of the CAD data of parts in the group is determined prior to the order of priority of the CAD data of parts out of the group by the means for determining priorities.

8. An apparatus according to any one of claims 1 to 4, further comprising:
recording part for recording a record in a common file, the record showing the part being referenced or updated, the common file including each record corresponding to a plurality of the parts.

9. An apparatus for loading CAD data according to claim 1, further comprising:
determining part for determining whether the CAD data of the parts are completely loaded with a allowable amount of memory being exceeded; and
making part for making transition from complete loading to display-loading for the completely loaded parts in ascending order of the determined priorities of the parts until the allowable amount of memory is not exceeded when the CAD data of parts are completely loaded with the allowable amount of memory being exceeded.

10. A method for loading computer-aided design (CAD) data generated by a CAD system, the method including the steps of:
obtaining parts that constitute a management model by the processor;
determining priorities on the basis of references to and/or updates of the obtained parts;
performing complete loading of parts having high priorities within an allowable amount of memory; and
performing display loading of parts that are not completely loaded.

11. A program storage medium readable by a processor, the program storage medium storing a method for loading computer aided design (CAD) data, the CAD data being loaded in a manner of a display loading for loading first data necessary to display a shape of the part and in a manner of a complete loading for loading first data and second data associated with the part, the CAD data including a plurality of pieces of CAD data, the plurality of pieces of CAD data corresponding to a group of parts a design object generated by the CAD system, the method comprising the steps of:
obtaining parts that constitute a management model by the processor;
determining priorities on the basis of references to and/or updates of the obtained parts;
performing complete loading of parts having high priorities within an allowable amount of memory; and
performing display loading of parts that are not completely loaded.

12. An apparatus for a computer-aided design (CAD) capable of generating CAD data including a plurality of pieces of CAD data for parts constituting a design object, the apparatus capable of loading the CAD data in forms of a display-loading or a complete loading, the display-loading being a loading of CAD data of a part to display the part, the complete loading being a loading of CAD data of a part to update or reference the CAD data, the apparatus comprising:
obtaining part for obtaining the CAD data of parts;
determining part for determining priorities of each of the pieces of the CAD data on the basis where the obtained CAD data of the parts is referenced and/or updated in the CAD system;
performing part for performing the complete loading of the CAD data of the parts in order of priority until an allowable amount of memory is reached; and
performing part for performing the display-loading of parts that are not completely loaded.
